(19) United States
(12) Patent Application Publication
(10) Pub. No.: US 2024/0308473 A1
(43) Pub. Date: Sep. 19, 2024

(54) Wiper Blade with Debossed Textured Surface

(71) Applicant: Illinois Tool Works Inc., Glenview, IL (US)

(72) Inventor: Martin William Rosas, Cypress, TX (US)

(21) Appl. No.: 18/590,180

(22) Filed: Feb. 28, 2024

Related U.S. Application Data
(60) Provisional application No. 63/452,490, filed on Mar. 16, 2023.

(51) Int. Cl. B60S 1/38

(52) U.S. Cl. CPC B60S 1/38; B60S 2001/3829

(57) ABSTRACT

Described is a wiper blade for a windshield of a vehicle. The wiper blade having a frame structure, a squeegee, and a plurality of debossed features. The squeegee is coupled to the frame structure and includes a wiping lip. The plurality of debossed features is formed in a side wall of the wiping lip. The plurality of debossed features extend along a length of the wiping lip. Each of the plurality of debossed features can also include treatment compound.

### RELATED APPLICATION

The present application claims priority to U.S. Provisional Patent Application No. 63/452,490, filed Mar. 16, 2023, and entitled “Wiper Blade With Debossed Textured Surface,” which is hereby incorporated by reference in its entirety.

### BACKGROUND

Windshield wipers are used to remove rain, snow, ice, washer fluid, water, and/or other debris from a vehicle's front or rear windshield. Almost all vehicles are equipped with one or more windshield wipers, including cars, trucks, buses, train locomotives, watercraft (e.g., those with a cabin) and even some aircraft. In many jurisdictions, windshield wipers are a legal requirement.

Vehicles use a variety of wiper blade types and configurations, but a common objective for all wiper blade types is that they conform to the surface and/or contour of the glass upon which they are mounted (whether a front or rear windshield) to effectively clear the windshield. Wiper blades are typically optimized to perform against liquid, but not to effectively remove common debris from the windshield, such as dirt, insects, bird waste, and other forms of organic debris.

Prior attempts to address the debris removal used embossed features on the wiper blade rubber element surface. However, such embossed features do not allow the rubber element to make proper contact with the windshield and often result in poor wipe quality performance. To overcome the poor performance, these designs often result in the use of two rubber elements used in tandem. For example, a first, embossed, rubber element to remove the organic debris, and the second rubber element removes streaks from the windshield. U.S. Pat. No. 7,735,184 to Donald Westbrook, for example, describes such a windshield wiper comprising a dual blade design wherein a portion of the outside surface of each blades has an embossed scrubbing surface. Dual blade designs, however, result in added cost, material usage, and complexity.

Despite advancements to date, a need exists for an improved wiper blade that can effectively clear debris without introducing streaks to the windshield.

### SUMMARY

The present disclosure relates generally to an improved wiper blade, substantially as illustrated by and described in connection with at least one of the figures, as set forth more completely in the claims. More specifically, the present disclosure relates to an improved wiper blade that can effectively clear debris without introducing streaks to the windshield.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an example vehicle having a windshield and a pair of wiper blades.

FIG. 1b illustrates an assembly view of an example connection point between the wiper blade and the wiper arm.

FIGS. 2a and 2b illustrate perspective side and end views of a wiper blade in accordance with an aspect of the present disclosure.

FIG. 3 illustrates a cross-sectional view of the wiper blade of FIGS. 2a and 2b having a treatment compound to aid in debris removal efficacy in accordance with an aspect of the present disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Wiper blades used in vehicles vary in size and shape. In some cases, wiper blades can be the same shape, but will vary in size. While wiper blades are most often associated with automobiles (e.g., cars, trucks, etc.), they are likewise employed in numerous other vehicles, such as trains, watercraft, and aircraft. Therefore, the following disclosure should not be limited to wiper blades and wiper arms used in automobiles, but rather would be applicable to wiper blades and wiper arms used in any type of vehicle.

The present disclosure relates to an improved wiper blade that can effectively clear debris without introducing streaks to the windshield or requiring a secondary wiper blade. In one example, a wiper blade comprises a frame structure, a squeegee coupled to the frame structure, and a plurality of debossed features. The squeegee comprising a wiping lip. The plurality of debossed features formed on a side wall of the wiping lip. The plurality of debossed features is distributed along a length of the wiping lip. Each of the plurality of debossed features can be a recessed cavity. For example, the recessed cavity can be a bowl-shaped cavity, a pyramid-shaped cavity, and/or a cylinder-shaped cavity. The plurality of debossed features can be arranged in a grid pattern. In some examples, the wiping lip comprises a treatment compound. The treatment compound can be provided in one or more of the plurality of debossed features. The treatment compound can be provided in a form of a bead. In some examples, the treatment compound can be a wax, a non-stick coating, and/or a water repellant.

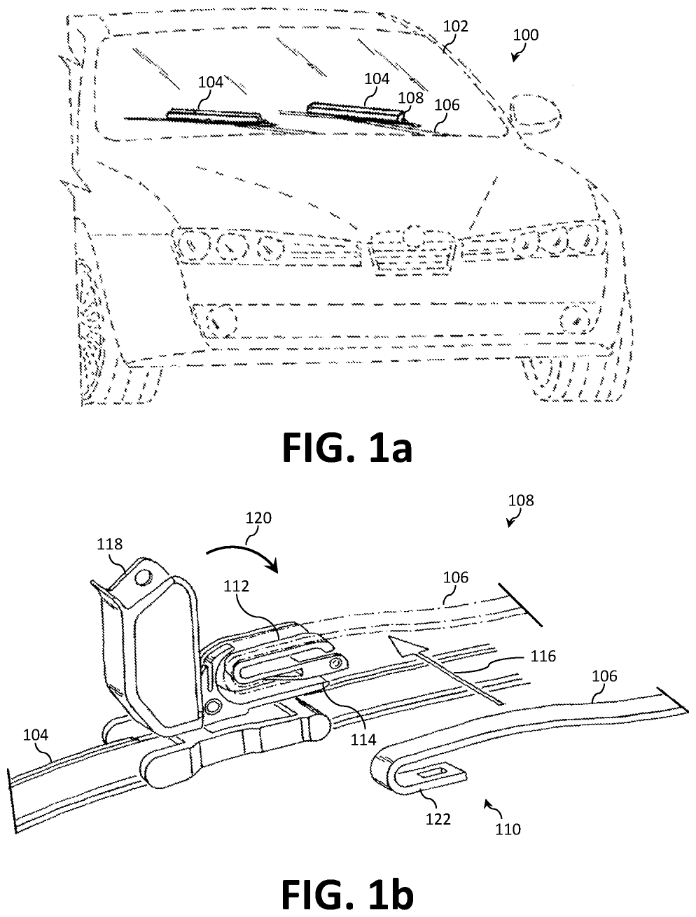

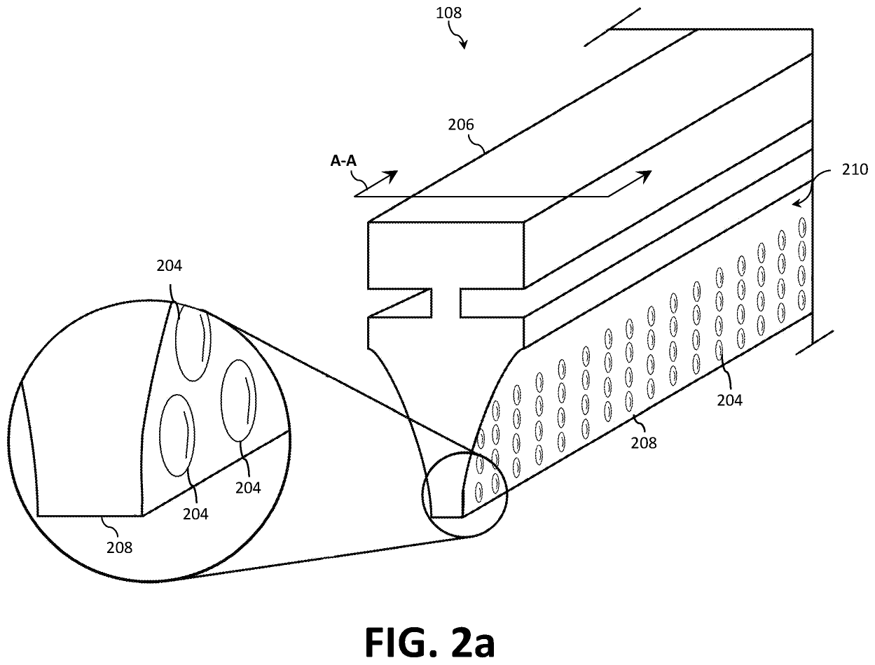

FIG. 1a illustrates an example vehicle 100 having a windshield 102 and a pair of wiper blades 104. As illustrated, each wiper blade 104 is removably coupled to a wiper arm 106 of the vehicle 100 via a coupling 108. As is known in the art, the wiper arms 106 (and, therefore, the wiper blades 104) are configured to translate back and forth across the windshield 102 to clear the windshield 102 of rain, snow, and debris via one or more electric motors and mechanical linkages associated with the vehicle 100.

FIG. 1b illustrates an assembly view of an example coupling 108 between the wiper blade 104 and the wiper arm 106. As illustrated, each wiper arm 106 includes or otherwise defines, at its distal end, an arm-side connector 110. The arm-side connector 110 is configured to engage and secure the wiper blade 104 via a complimentary blade-side connector 112 positioned on or otherwise associated with the wiper blade 104. In the illustrated example, the arm-side connector 110 is inserted into a J-shaped slot 114 of the blade-side connector 112 as indicated by arrow 116. Once assembled, a locking cap 118 can be folded as indicated by arrow 120 (e.g., pivoted about a hinge) and positioned to cover, secure, and protect the connected arm-side connector 110 and blade-side connector 112. In the illustrated example, the wiper arm 106 includes an arm-side connector 110 configured a J-Hook connector 122, but other connector types are contemplated.

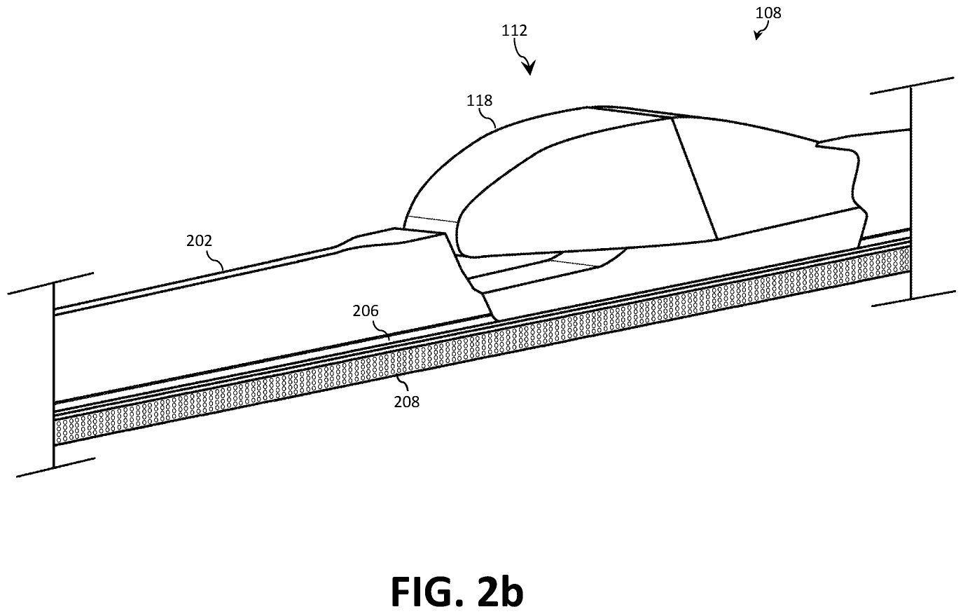

FIGS. 2a and 2b illustrate perspective side and end views of a wiper blade 104 in accordance with an aspect of the present disclosure. The wiper blade 104 generally comprises a frame structure 202, a squeegee 206, a wiping lip 208, and a plurality of debossed features 204 formed in the wiping lip 208.

The windshield wiper blade 104 and components thereof (e.g., the frame structure 202, the squeegee 206, and/or wiping lip 208) can be fabricated from one or more elastomeric materials. Example elastomeric materials include, for example, thermoplastic polyurethane (TPU), thermoplastic vulcanizates (TPV), thermoplastic elastomers (TPE), flexible polyurethane (FPU), silicon, etc. The frame structure 202 is configured to couple to the wiper arm 106 via the blade-side connector 112 of the coupling 108. The blade-side connector 112 may be integral with the frame structure 202 or attached thereto via one or more fasteners, adhesives, etc.

As illustrated, the proposed wiper blade 104 comprises a plurality of debossed features 204 distributed along the length of the wiping lip 208 (e.g., a rubber element surface) to remove organic debris. The plurality of debossed features 204 can be distributed on each side of the wiping lip 208. The plurality of debossed features 204 allows for the use of a single the wiping lip 208; therefore, reducing material cost and manufacturing complexity. The plurality of debossed features 204 can be formed in a side wall 210 of the wiping lip 208. The plurality of debossed features 204, in effect, increase the surface area of the side wall 210 of the wiping lip 208, while also introduction geometries that capture the debris, while leaving a streak-free finish. The length of the wiping lip 208 will depend on the vehicle 100 as the length of a wiper blade 104 (and thus the quantity of debossed features 204) will vary depending on the type of vehicle.

The debossed features 204 can be molded into the wiping lip 208 (e.g., during manufacture thereof) or cut or carved into the wiping lip 208 (e.g., after manufacture thereof, whether mechanically or via a laser). In the illustrated example, the debossed features 204 are provided in the form of generally bowl-shaped, recessed cavities (e.g., concave dimples). While illustrated as generally bowl-shaped, recessed cavities, other shapes are contemplated for the debossed features 204 including, for example, spheroids, pyramids, cylinders, cuboids, ridges, etc. Similarly, the plurality of debossed features 204 are illustrated as being arranged in the side wall 210 in a grid pattern, but other patterns are contemplated, such as spirals, helix, etc.

In some examples, two or more components of the windshield wiper blade 104 can be formed from the same material and/or as a single, integrated component. For example, the squeegee 206 and the wiping lip 208 could be fabricated as a single component. In some examples, the windshield wiper blade 104 (or a portion thereof) can be a printed plastic material component (e.g., thermoplastic, TPU, FPU, etc.). Printed plastic material components can be printed with great accuracy and with numerous details, which is particularly advantageous, for example, in creating components requiring complex and/or precise features. In addition, additive manufacturing techniques obviate the need for mold tooling, thereby lowering up-front manufacturing costs, which is particularly advantageous in low-volume productions. In some examples, the windshield wiper blade 104 may be fabricated using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

In some examples, a coating may be applied over the wiping lip 208 and/or the plurality of debossed features 204 to mitigate the effects of the environment, such as debris. For example, the coating may be a non-stick coating that mitigates the effects of debris by easily brushing the debris away from the wiping lip 208 and/or the plurality of debossed features 204.

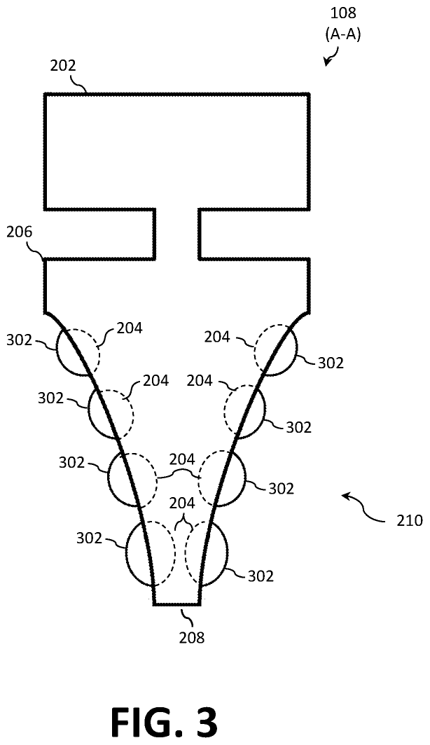

FIG. 3 illustrates a cross-sectional view of the wiper blade 104 in accordance with an aspect of the present disclosure taken along cut line A-A and having a treatment compound 302 formed thereon to aid in debris removal efficacy. The treatment compound 302 comprises one or more chemical formulations to aid in debris removal efficacy. Therefore, in addition to reducing material cost and manufacturing complexity, the plurality of debossed features 204 allows for the incorporation of a treatment compound 302 to aid in debris removal efficacy. For example, the recessed areas defined by the plurality of debossed features 204 in the wiping lip 208 could house a treatment compound 302, which could be a wax, soap, water repellant, or other windshield treatment formulation. The treatment compound 302 can be sprayed onto the wiping lip 208, printed onto the wiping lip 208, or otherwise applied to the wiping lip 208. For example, commonly-owned U.S. Patent Publication No. 2013/0045332A1 to Jiafu Fang et al. describes a water repellant coating that can could be used as the treatment compound 302.

As illustrated, the treatment compound 302 can be provided in a form of a bead, which could slowly dissolve overtime onto the surface windshield 102 and aid in cleaning. The raised textured of the illustrated bead surface could additionally function as an abrasive surface to further aid in debris removal. The bead, for example, may be water soluble such that it dissolves when in contact with water or another liquid to aid in remove of debris. Once the treatment compound 302 (whether a wax, soap, or other formulation) has been depleted, the indented surface of the now-emptied debossed features 204 would continue to act as a textured abrasive, recessed, surface to aid in further debris removal.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A wiper blade comprising:
a frame structure;
a squeegee coupled to the frame structure, wherein the squeegee comprises a wiping lip; and
a plurality of debossed features formed on a side wall of the wiping lip, wherein the plurality of debossed features is distributed along a length of the wiping lip.

2. The wiper blade of claim 1, wherein each of the plurality of debossed features is a recessed cavity.

3. The wiper blade of claim 2, wherein the recessed cavity is a bowl-shaped cavity.

4. The wiper blade of claim 1, wherein the plurality of debossed features is arranged in a grid pattern.

5. The wiper blade of claim 1, wherein the wiping lip comprises a treatment compound.

6. The wiper blade of claim 5, wherein the treatment compound is provided in one or more of the plurality of debossed features.

7. The wiper blade of claim 6, wherein the treatment compound is provided in a form of a bead.

8. The wiper blade of claim 6, wherein the treatment compound is a wax.

9. The wiper blade of claim 6, wherein the treatment compound is a non-stick coating.

10. The wiper blade of claim 6, wherein the treatment compound is a water repellant.

11. The wiper blade of claim 3, wherein the recessed cavity is a pyramid-shaped cavity.

12. The wiper blade of claim 3, wherein the recessed cavity is a cylinder-shaped cavity.

13. A wiper blade comprising:
a squeegee having a wiping lip; and
a plurality of debossed features formed on a side wall of the wiping lip,
wherein the plurality of debossed features is distributed along a length of the wiping lip, and
wherein the wiping lip comprises a treatment compound.

14. The wiper blade of claim 13, wherein each of the plurality of debossed features is a recessed cavity.

15. The wiper blade of claim 13, wherein the plurality of debossed features is arranged in a grid pattern.

16. The wiper blade of claim 13, wherein the treatment compound is provided in one or more of the plurality of debossed features.

17. The wiper blade of claim 13, wherein the treatment compound is provided in a form of a bead.

18. A wiper blade comprising:
a squeegee having a wiping lip; and
a plurality of debossed features formed on a side wall of the wiping lip and arranged in a grid pattern,
wherein the plurality of debossed features is distributed along a length of the wiping lip, and
wherein the wiping lip comprises a treatment compound.

19. The wiper blade of claim 18, wherein each of the plurality of debossed features is a recessed cavity, and wherein the treatment compound is provided in one or more of the plurality of debossed features.

20. The wiper blade of claim 18, wherein the treatment compound is a wax or a non-stick coating.
